(19) United States
(12) Patent Application Publication
(10) Pub. No.: US 2025/0258481 A1
(43) Pub. Date: Aug. 14, 2025

(54) ELECTRONIC DEVICE FOR DISPLAYING USER INTERFACE FOR USE AND MANAGEMENT OF DEVICE INCLUDED IN HOUSE, AND OPERATING METHOD THEREOF

(71) Applicant: Samsung Electronics Co., Ltd., Suwon-si (KR)

(72) Inventors: Kyungjun LEE, Suwon-si (KR); Yukyoung LEE, Suwon-si (KR); Heejeong CHOO, Suwon-si (KR)

(21) Appl. No.: 19/191,822

(22) Filed: Apr. 28, 2025

Related U.S. Application Data
(63) Continuation of application No. PCT/KR2023/013836, filed on Sep. 14, 2023.

(30) Foreign Application Priority Data
Nov. 1, 2022 (KR) 10-2022-0143797

(51) Int. Cl. G05B 19/418; G06F 3/0486

(52) U.S. Cl. CPC G05B 19/418; G06F 3/0486; G05B 2219/2642

(57) ABSTRACT

A method performed by an electronic device for controlling a plurality of devices in a house is provided. The method includes displaying a first user interface where a plurality of first objects corresponding to a plurality of devices are arranged according to a predetermined layout to correspond to a structure of a house, identifying a first user input for selecting a category of a device to be controlled through a second object included in the first user interface, identifying at least one device included in the selected category in response to identifying the first user input, displaying a second user interface where at least one first object corresponding to the at least one device is arranged according to a layout, identifying a second user input for changing a location on the layout of one first object among the at least one first object displayed on the second user interface according to the layout, determining whether a device corresponding to the one first object is relocatable in response to identifying the second user input, when it is determined that the device corresponding to the one first object is relocatable, changing and displaying the location on the layout of the one first object to correspond to the second user input, and, when it is determined that the device corresponding to the one first object is not relocatable, displaying information indicating that relocating is impossible.

### CROSS-REFERENCE TO RELATED APPLICATION(S)

This application is a continuation application, claiming priority under 35 U.S.C. § 365(c), of an International application No. PCT/KR2023/013836, filed on Sep. 14, 2023, which is based on and claims the benefit of a Korean patent application number 10-2022-0143797, filed on Nov. 1, 2022, in the Korean Intellectual Property Office, the disclosure of which is incorporated by reference herein in its entirety.

### BACKGROUND

### 1. Field

The disclosure relates to an electronic device and an operation method thereof for displaying a user interface to use and manage devices in a house.

### 2. Description of Related Art

The growth of wireless communication technology leads to development of smart apartment-related techniques for controlling devices (e.g., televisions (TVs), air conditioners, fridges, air purifiers, smart plugs, or lightings) in an apartment on the user's portable terminal. In relation, developed are cloud services for bundling and linking built-in IoT devices, home services, and IoT networks disposed in the apartment to all smart devices through the user's portable terminal and user interfaces related to the cloud services. Through the user interface for a smart apartment, users may easily control various devices in a house through simple operations of a portable terminal.

The above information is presented as background information only to assist with an understanding of the disclosure. No determination has been made, and no assertion is made, as to whether any of the above might be applicable as prior art with regard to the disclosure.

### SUMMARY

As the types and number of devices placed in houses increase, a user interface for smart apartments that is easy for users to use is required.

Aspects of the disclosure are to address at least the above-mentioned problems and/or disadvantages and to provide at least the advantages described below. Accordingly, an aspect of the disclosure is to provide an electronic device and an operation method thereof for displaying a user interface to allow the user to easily control devices placed in a house.

Another aspect of the disclosure is to provide an electronic device and an operation method thereof for displaying a user interface to, when devices are added or removed or relocated in a house, allow the user to easily recognize the same and apply the change.

Another aspect of the disclosure is to provide an electronic device and an operation method thereof for displaying a user interface to easily control devices using a specific mode or an automation function.

Additional aspects will be set forth in part in the description which follows and, in part, will be apparent from the description, or may be learned by practice of the presented embodiments.

In accordance with an aspect of the disclosure, a method performed by an electronic device for controlling a plurality of devices in a house is provided. The method includes displaying a first user interface where a plurality of first objects corresponding to the plurality of devices are disposed according to a predetermined layout to correspond to a structure of the house, identifying a first user input for selecting a category of a device to be controlled through a second object included in the first user interface, identifying at least one device included in the selected category in response to identifying the first user input, displaying a second user interface where at least one first object corresponding to the at least one device is disposed according to the layout, identifying a second user input for changing a location on the layout of one first object among the at least one first object displayed on the second user interface according to the layout, determining whether a device corresponding to the one first object is relocatable in response to identifying the second user input, when it is determined that the device corresponding to the one first object is relocatable, changing and displaying the location on the layout of the one first object to correspond to the second user input, and when it is determined that the device corresponding to the one first object is not relocatable, displaying information indicating that relocating is impossible.

The method further includes receiving information about the predetermined layout from memory of the electronic device or a server providing a smart apartment service. The method wherein the predetermined layout includes a plurality of areas, and the plurality of areas respectively correspond to spaces in the house.

The method wherein the plurality of areas include a shared area corresponding to a shared space other than the house.

The method wherein the second user input for changing the location on the layout of the one first object includes an input of dragging the one first object from one area among the plurality of areas to another area.

The method further includes identifying a user input for enlarging one area among the plurality of areas, and enlarging and displaying the one area.

The method further includes identifying one or more first objects displayed in the one area, identifying an operation state of one or more devices corresponding to the one or more first objects, and displaying one or more objects including an operation state of the identified one or more devices.

The method further includes, when determining that the device corresponding to the one first object is relocatable, displaying information indicating that relocating according to the second user input succeeds.

The method further includes receiving information about whether the device corresponding to the one first object is a fixed device from the server, and determining whether the device corresponding to the one first object is relocatable based on the received information.

The method further includes identifying a user input for selecting an operation mode of the electronic device, identifying at least one operation device controlled according to the operation mode, and displaying an object indicating a result of executing the at least one operation device.

In accordance with another aspect of the disclosure, an electronic device for controlling a plurality of devices in a house is provided. The electronic device includes memory, comprising one or more storage media, storing instructions, and at least one processor communicatively coupled to the memory, wherein the instructions, when executed by the at least one processor individually or collectively, cause the electronic device to display a first user interface where a plurality of first objects corresponding to the plurality of devices are disposed according to a predetermined layout to correspond to a structure of the house, identify a first user input for selecting a category of a device to be controlled through a second object included in the first user interface, identify at least one device included in the selected category in response to identifying the first user input, display a second user interface where at least one first object corresponding to the at least one device is disposed according to the layout, identify a second user input for changing a location on the layout of one first object among the at least one first object displayed on the second user interface according to the layout, determine whether a device corresponding to the one first object is relocatable in response to identifying the second user input, when it is determined that the device corresponding to the one first object is relocatable, change and display the location on the layout of the one first object to correspond to the second user input, and when it is determined that the device corresponding to the one first object is not relocatable, display information indicating that relocating is impossible.

The instructions that, when executed by the at least one processor individually or collectively, further cause the electronic device to receive information about the predetermined layout from a memory of the electronic device or a server providing a smart apartment service.

The predetermined layout includes a plurality of areas, and the plurality of areas respectively correspond to spaces in the house.

The plurality of areas include a shared area corresponding to a shared space other than the house.

The second user input for changing the location on the layout of the one first object includes an input of dragging the one first object from one area among the plurality of areas to another area.

The instructions that, when executed by the at least one processor individually or collectively, further cause the electronic device to identify a user input for enlarging one area among the plurality of areas, and enlarge and display the one area.

The instructions that, when executed by the at least one processor individually or collectively, further cause the electronic device to identify one or more first objects displayed in the one area, identify an operation state of one or more devices corresponding to the one or more first objects, and display one or more objects including an operation state of the identified one or more devices.

The instructions that, when executed by the at least one processor individually or collectively, further cause the electronic device to, when determining that the device corresponding to the one first object is relocatable, display information indicating that relocating according to the second user input succeeds.

The instructions that, when executed by the at least one processor individually or collectively, further cause the electronic device to receive information about whether the device corresponding to the one first object is a fixed device from the server, and determine whether the device corresponding to the one first object is relocatable based on the received information.

The instructions that, when executed by the at least one processor individually or collectively, further cause the electronic device to identify a user input for selecting an operation mode of the electronic device, identify at least one operation device controlled according to the operation mode, and display an object indicating a result of executing the at least one operation device.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include displaying a first user interface where a plurality of first objects corresponding to a plurality of devices are disposed according to a predetermined layout to correspond to a structure of a house, identifying a first user input for selecting a category of a device to be controlled through a second object included in the first user interface, identifying at least one device included in the selected category in response to identifying the first user input, displaying a second user interface where at least one first object corresponding to the at least one device is disposed according to the layout, identifying a second user input for changing a location on the layout of one first object among the at least one first object displayed on the second user interface according to the layout, determining whether a device corresponding to the one first object is relocatable in response to identifying the second user input, when it is determined that the device corresponding to the one first object is relocatable, changing and displaying the location on the layout of the one first object to correspond to the second user input, and, when it is determined that the device corresponding to the one first object is not relocatable, displaying information indicating that relocating is impossible.

According to the examples of the disclosure, devices in a house may be easily managed and controlled by the user.

Further, when there is a change in device layout such as a change in the location of devices in a house or a new device is added, the user may easily apply the changes.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating a configuration of an electronic device according to an embodiment of the disclosure;

FIG. 2 is a block diagram illustrating a configuration of a program according to an embodiment of the disclosure;

FIG. 3 illustrates an example of a user interface displayed on an electronic device according to an embodiment of the disclosure;

FIG. 4 illustrates an operation flow of an electronic device according to an embodiment of the disclosure;

FIG. 5 illustrates an example of a user interface for device editing of an electronic device according to an embodiment of the disclosure;

FIG. 6 illustrates an example of a user interface for device editing of an electronic device according to an embodiment of the disclosure;

FIG. 7 illustrates an example of a user interface for device identification and editing of an electronic device according to an embodiment of the disclosure;

FIG. 8A illustrates an example of a user interface for device use of an electronic device according to an embodiment of the disclosure;

FIG. 8B illustrates an example of a user interface for device use of an electronic device according to an embodiment of the disclosure;

FIG. 9 illustrates an example of a user interface for mode change of an electronic device according to an embodiment of the disclosure; and

FIG. 10 illustrates an example of a user interface for automation function use of an electronic device according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

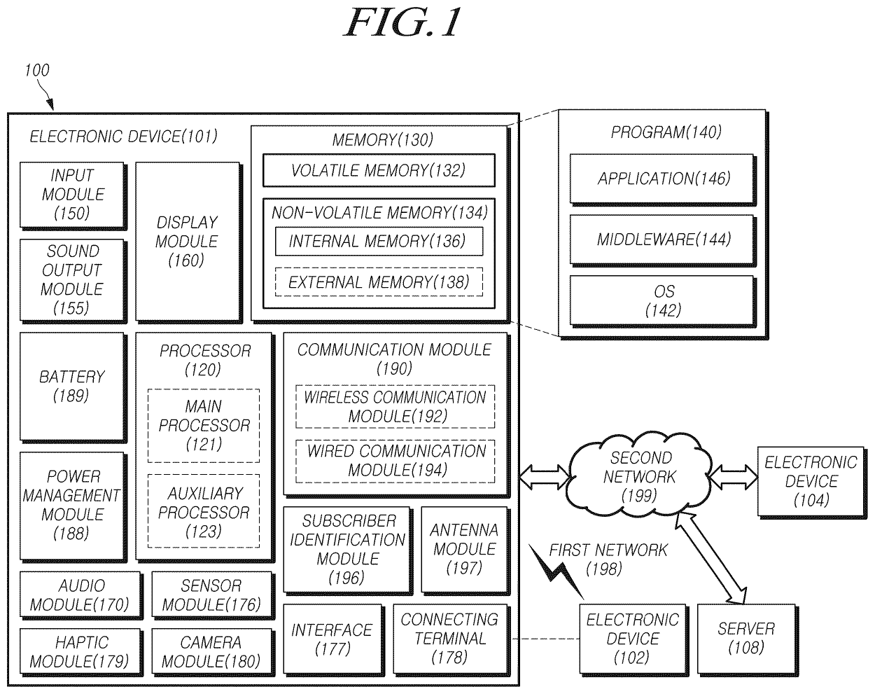

FIG. 1 is a block diagram illustrating an electronic device in a network environment according to an embodiment of the disclosure.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™ wireless-fidelity (Wi-Fi) direct, or infrared data association (IrDA)) or a second network 199 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102 or 104 or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

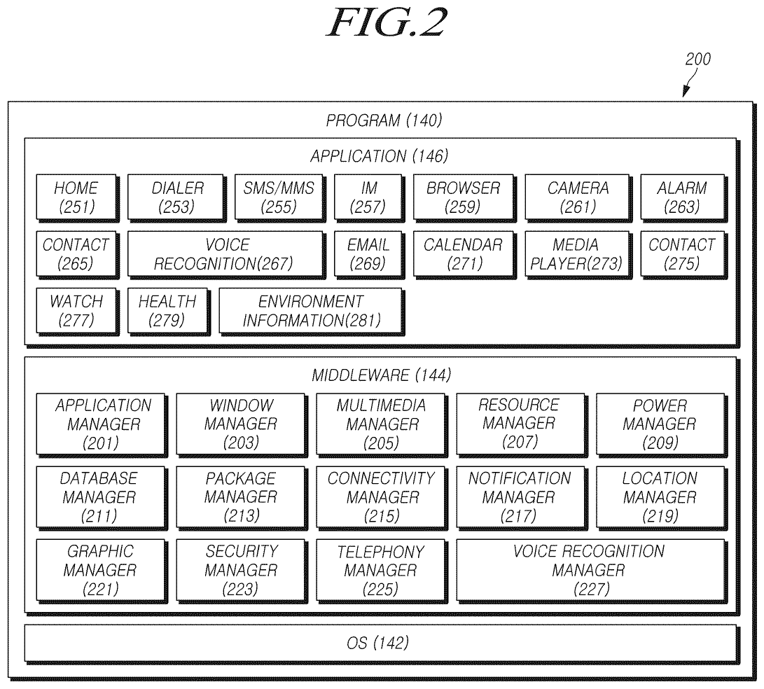

FIG. 2 is a block diagram illustrating the program according to an embodiment of the disclosure. According to an embodiment, the program 140 illustrated in block diagram 200 may include an operating system (OS) 142 to control one or more resources of the electronic device 101, middleware 144, or an application 146 executable in the OS 142. The OS 142 may include, for example, Android™, iOS™, Windows™, Symbian™, Tizen™, or Bada™. At least part of the program 140, for example, may be pre-loaded on the electronic device 101 during manufacture, or may be downloaded from or updated by an external electronic device (e.g., the electronic device 102 or 104, or the server 108) during use by a user.

The OS 142 may control management (e.g., allocating or deallocation) of one or more system resources (e.g., process, memory, or power source) of the electronic device 101. The OS 142, additionally or alternatively, may include one or more driver programs to drive other hardware devices of the electronic device 101, for example, the input device 150, the sound output device 155, the display device 160, the audio module 170, the sensor module 176, the interface 177, the haptic module 179, the camera module 180, the power management module 188, the battery 189, the communication module 190, the subscriber identification module 196, or the antenna module 197.

The middleware 144 may provide various functions to the application 146 such that a function or information provided from one or more resources of the electronic device 101 may be used by the application 146. The middleware 144 may include, for example, an application manager 201, a window manager 203, a multimedia manager 205, a resource manager 207, a power manager 209, a database manager 211, a package manager 213, a connectivity manager 215, a notification manager 217, a location manager 219, a graphic manager 221, a security manager 223, a telephony manager 225, or a voice recognition manager 227.

The application manager 201, for example, may manage the life cycle of the application 146. The window manager 203, for example, may manage one or more graphical user interface (GUI) resources that are used on a screen. The multimedia manager 205, for example, may identify one or more formats to be used to play media files, and may encode or decode a corresponding one of the media files using a codec appropriate for a corresponding format selected from the one or more formats. The resource manager 207, for example, may manage the source code of the application 146 or a memory space of the memory 130. The power manager 209, for example, may manage the capacity, temperature, or power of the battery 189, and determine or provide related information to be used for the operation of the electronic device 101 based at least in part on corresponding information of the capacity, temperature, or power of the battery 189. According to an embodiment, the power manager 209 may interwork with a basic input/output system (BIOS) (not shown) of the electronic device 101.

The database manager 211, for example, may generate, search, or change a database to be used by the application 146. The package manager 213, for example, may manage installation or update of an application that is distributed in the form of a package file. The connectivity manager 215, for example, may manage a wireless connection or a direct connection between the electronic device 101 and the external electronic device. The notification manager 217, for example, may provide a function to notify a user of an occurrence of a specified event (e.g., an incoming call, message, or alert). The location manager 219, for example, may manage locational information on the electronic device 101. The graphic manager 221, for example, may manage one or more graphic effects to be offered to a user or a user interface related to the one or more graphic effects.

The security manager 223, for example, may provide system security or user authentication. The telephony manager 225, for example, may manage a voice call function or a video call function provided by the electronic device 101. The voice recognition manager 227, for example, may transmit a user's voice data to the server 108, and receive, from the server 108, a command corresponding to a function to be executed on the electronic device 101 based at least in part on the voice data, or text data converted based at least in part on the voice data. According to an embodiment, the middleware 244 may dynamically delete some existing components or add new components. According to an embodiment, at least part of the middleware 144 may be included as part of the OS 142 or may be implemented as another software separate from the OS 142.

The application 146 may include, for example, a home 251, a dialer 253, a short message service (SMS)/multimedia messaging service (MMS) 255, an instant message (IM) 257, a browser 259, a camera 261, an alarm 263, a contact 265, a voice recognition 267, an email 269, a calendar 271, a media player 273, a contact 275, a watch 277, a health 279 (e.g., for measuring the degree of workout or biometric information, such as blood sugar), or an environmental information 281 (e.g., for measuring air pressure, humidity, or temperature information) application. According to an embodiment, the application 146 may further include an information exchanging application (not shown) that is capable of supporting information exchange between the electronic device 101 and the external electronic device. The information exchange application, for example, may include a notification relay application adapted to transfer designated information (e.g., a call, message, or alert) to the external electronic device or a device management application adapted to manage the external electronic device. The notification relay application may transfer notification information corresponding to an occurrence of a specified event (e.g., receipt of an email) at another application (e.g., the email application 269) of the electronic device 101 to the external electronic device. Additionally or alternatively, the notification relay application may receive notification information from the external electronic device and provide the notification information to a user of the electronic device 101.

The device management application may control the power (e.g., turn-on or turn-off) or the function (e.g., adjustment of brightness, resolution, or focus) of the external electronic device or some component thereof (e.g., a display device or a camera module of the external electronic device). The device management application, additionally or alternatively, may support installation, delete, or update of an application running on the external electronic device.

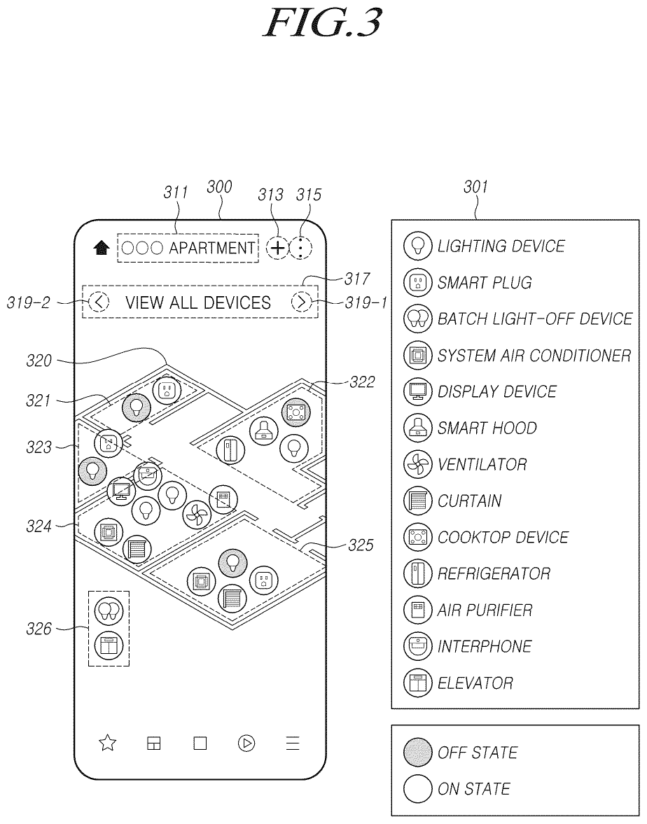

FIG. 3 illustrates an example of a user interface of an electronic device according to an embodiment of the disclosure. The electronic device of FIG. 3 may represent a device corresponding to the electronic device 101 of FIG. 1.

The user interface 300 according to an embodiment refers to the user interface displayed on the user terminal (e.g., smartphone) to identify and control various types of IoT devices (e.g., TVs, refrigerators, air conditioners, air purifiers, sound bars, etc.) and other devices (e.g., lighting devices, batch light-off devices, cooktops, smart hoods, ventilators, etc.) disposed in a house such as an apartment.

The user interface displayed on the electronic device according to an embodiment may display objects corresponding to devices disposed in the house in the form of icons. With the development of technology related to IoT devices, various types and a large number of devices may be increasingly included in the house. In the user interface for IoT device management, displaying devices in the form of a map view, i.e., icons disposed for each room in the house, rather than displaying devices in the form of cards or a list, may lead users to easy use, contributing to enhancing user experience. Further, when the map view is applied to a preset mode (e.g., sleep mode, away mode, tropical night mode, etc.) and automation functions, devices related to the mode and automation function may be grasped at a glance, and how they operate may be easily identified, providing an effect that makes the mode and automation easier to use.

Referring to FIG. 3, the user interface 300 may include an object 311 representing information about the apartment, an object 313 for identifying a user input for adding a device to the user interface 300, an object 315 for identifying a user input for performing another function (e.g., an edit function, a function through another mode, or an automation function) of the user interface 300, a second object 319-1 or 319-2 for identifying a first user input for selecting a category of a device to be controlled, an object 317 for representing a category of a device currently displayed on the user interface 300, and a plurality of first objects corresponding to devices disposed on a predetermined layout 320.

In an embodiment, the electronic device may display information for indicating information about the apartment through the object 311.

In an embodiment, the electronic device may identify a user input for adding a device to be displayed on the user interface 300 through the object 313. For example, although not illustrated in the drawings, when the electronic device identifies a user input through the object 313, the electronic device may display an object (not illustrated) (e.g., receiving device information through a pop-up window and selecting the location where the device is to be disposed) for receiving a user input for selecting information about a device to be added information about the location where the device to be added is to be disposed.

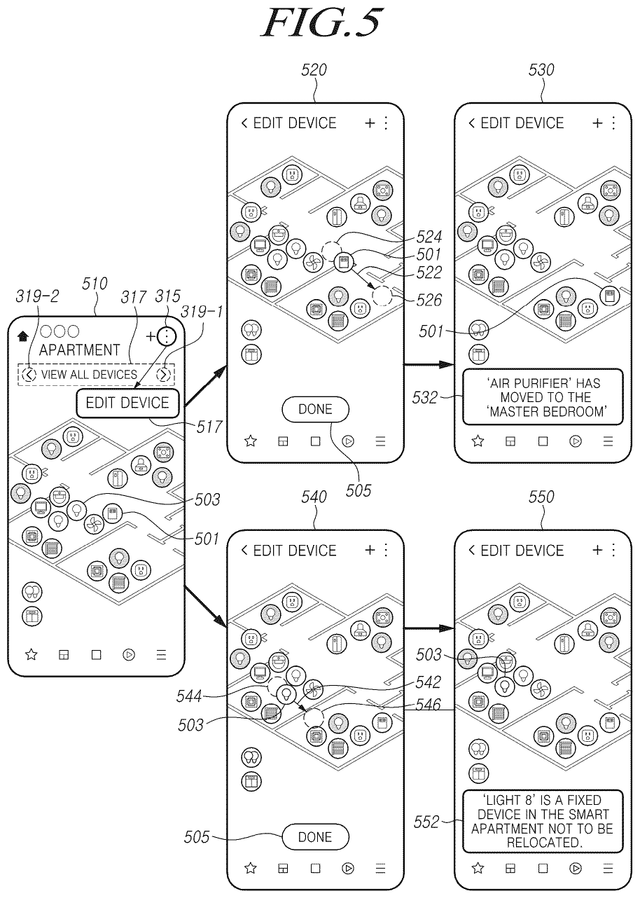

In an embodiment, when identifying the user input through the object 315, the electronic device may display another object related to the use, editing, or performing another function of devices displayed on the user interface 300. A description related thereto is given with reference to FIGS. 5 to 7, 8A, 8B, 9, and 10.

In an embodiment, the user interface 300 may include an object 317 representing the category of devices currently being displayed on the electronic device. For example, referring to FIG. 3, the object 317 may display information indicating that devices in all categories are displayed, such as “View all devices.” For example, the categories may include display devices (e.g., TVs, monitors), cooling/heating devices (e.g., air conditioners), air quality-related devices (e.g., air purifiers, smart hoods, ventilators, etc.), ceiling-mounted lighting devices, other lighting devices than ceiling-mounted lighting devices, devices (e.g., smart plugs, refrigerators, etc.) capable of displaying power usage, and other devices (e.g., robot vacuums).

In an embodiment, when identifying a user input through the second object 319-1 or 319-2, the electronic device may display a device included in a changed category. For example, when the electronic device identifies a user input through the second object 319-2, the electronic device may display the next category rather than the view all devices category. The categories may be displayed in a predetermined order, when identifying a user input through the second object 319-2, the next category may be displayed, and when identifying a user input through the second object 319-2, the previous category may be displayed. In an embodiment, although not illustrated in the drawings, when identifying an input of swiping the screen to the left or right, the electronic device may display the previous or next category.

In an embodiment, the layout 320 may mean data regarding a predetermined form corresponding to the structure of an apartment obtained through information stored in the memory of the electronic device or received from a server (not illustrated). For example, the layout may refer to data created to correspond to a floor plan representing the structure of a house where the user resides in the apartment. The example of the layout 320 illustrated in FIG. 3 is merely an example, and the layout 320 according to embodiments of the disclosure is not limited thereto. Even in the same apartment building, the layout may differ depending on the number, floor, or location (e.g., the number, size, structure, or arrangement of rooms).

In an embodiment, the layout 320 may include a first area 321, a second area 322, a third area 323, a fourth area 324, a fifth area 325, and a sixth area 326. Each area may refer to a room or space included in the house. For example, the second area 322 may refer to a kitchen space in the house. For example, the fourth area 324 may refer to a living room. For example, the fifth space may refer to a bedroom. In an embodiment, the sixth area 326 may refer to a shared area shared by all the occupants in the apartment building, not a dedicated area constituting the user's house.

In an embodiment, the user interface 300 may include a plurality of first objects corresponding to the plurality of devices included in the house. The plurality of first objects may have shapes of icons corresponding to the devices, respectively. The plurality of first objects may be displayed on the user interface 300 to correspond to the structure in which the device is disposed in the house.

In an embodiment, the table 301 represents a plurality of first objects displayed on the user interface 300.

In an embodiment, the plurality of devices may include a lighting device, a smart plug, a batch light-off device, a system air conditioner, a display device, a smart hood, a ventilator, a curtain, a cooktop device, a refrigerator, an air purifier, and an interphone.

In an embodiment, although not illustrated in the drawings, the plurality of devices may further include a heating device, a door lock device, a gas valve device, a dryer, a washer, an audio device, an air conditioner, a clothing care machine, a dishwasher, a kimchi refrigerator, or the like.

In an embodiment, the plurality of first objects may respectively correspond to the plurality of devices described above, and may be displayed in the form of separate icons.

Referring to FIG. 3, the first area 321 according to an embodiment may include first objects corresponding to a lighting device and a smart plug. The second area 322 according to an embodiment may include first objects corresponding to a refrigerator, a smart hood, a cooktop, and a lighting device. The third area 323 according to an embodiment may include first objects corresponding to a smart plug and a lighting device. The fourth area 324 according to an embodiment may include first objects corresponding to a display device, an interphone, two lighting devices, a curtain device, a system air conditioner, a ventilator, and an air purifier. The fifth area 325 according to an embodiment may include first objects corresponding to a lighting device, a system air conditioner, a curtain device, and a smart air conditioner. The sixth area 326 according to an embodiment may include first objects corresponding to a batch light-off device and an elevator device.

In an embodiment, each of the plurality of first objects may represent information (e.g., an operation state, a stopped state) about whether the device is operating. In the following description, a “first state” may be used in the same meaning as a state in which it is not operating (e.g., a light-off state, off), and a “second state” may be used in the same meaning as a state in which it is operating (e.g., a light-on state, on). For example, the lighting device included in the first area 321 may be in the first state. For example, the cooktop included in the second area 322 may be in the second state. For example, the air purifier included in the fourth area 324 may be in the second state.

In an embodiment, although not illustrated in the drawings, when identifying a user input of rotating on the user interface 300, the electronic device may rotate the screen in the direction according to the user input and display the user interface.

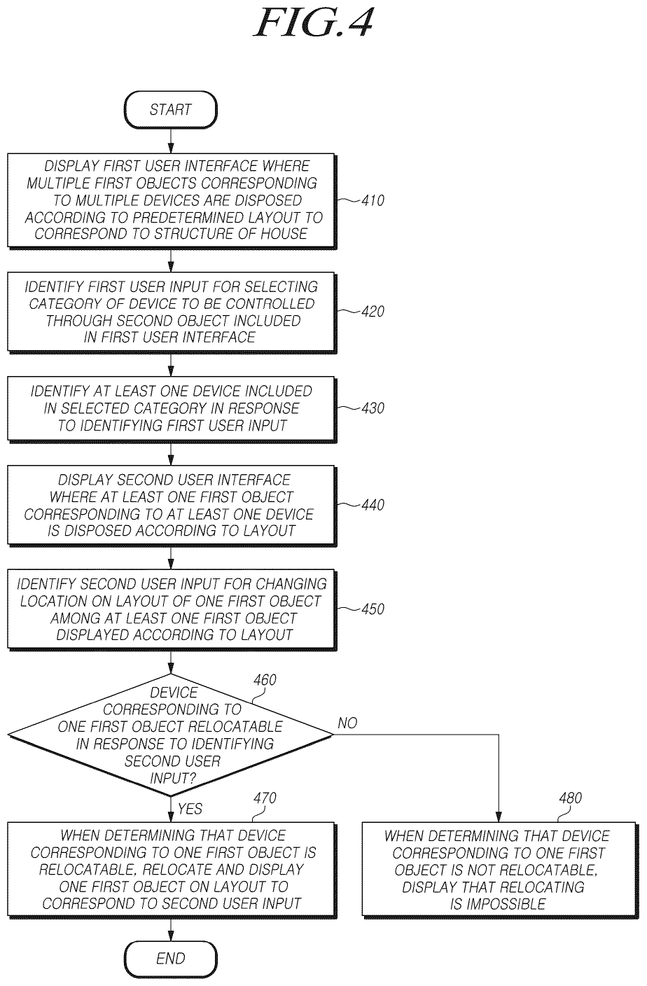

FIG. 4 illustrates an operation flow of an electronic device according to an embodiment of the disclosure. FIG. 5 illustrates an example of a user interface of an electronic device according to an embodiment of the disclosure. The electronic device of FIGS. 4 and 5 may be a device corresponding to the electronic device 101 of FIG. 1. A first user interface 510, a second user interface 520 or 540, or a third user interface 530 or 550 described in FIGS. 4 and 5 may refer to a user interface corresponding to the user interface 300 of FIG. 3, and content overlapping those described in FIG. 3 or components already defined in FIG. 3 may be skipped from the description.

According to an embodiment, in operation 410, the electronic device may display a first user interface in which a plurality of first objects corresponding to a plurality of devices are disposed according to a predetermined layout to correspond to the structure of the house. The plurality of first objects may refer to the plurality of first objects described above with reference to FIG. 3. In other words, the components illustrated in the form of circular icons in FIG. 5 may refer to the plurality of objects, respectively. The predetermined layout may correspond to the layout 320 described in FIG. 3. The first user interface may refer to the user interface 300 of FIG. 3. Referring to FIG. 5, the electronic device may display the first user interface 510. The first user interface 510 may include the plurality of first objects disposed according to the predetermined layout 320. For example, the first user interface may include a first object 501 and an object 503. The first object 501 may represent an object corresponding to an air purifier disposed in a fourth area (e.g., the fourth area 324), i.e., the living room, and the object 503 may represent an object corresponding to a lighting device disposed in the fourth area (e.g., the fourth area 324).

According to an embodiment, in operation 420, the electronic device may identify a first user input for selecting a category of a device to be controlled through a second object included in the first user interface. The second object may refer to the second object 319-1 or 319-2 of FIG. 3, and the first user input may refer to a user input identified through the second object 319-1 or 319-2.

In an embodiment, the category of the device to be controlled may include a first category including all of the plurality of devices, a second category including display devices (e.g., TVs or monitors), a third category including heating/cooling devices (e.g., system air conditioners, floor-standing air conditioners, or heating devices), a fourth category including devices for controlling state quality (e.g., air purifiers, smart hoods, or ventilators), a fifth category including ceiling-mounted lighting devices, a sixth category including other lighting devices other than ceiling-mounted lighting devices, a seventh category including devices capable of displaying power usage (e.g., smart plugs or refrigerators), and an eighth category including other devices (e.g., robot vacuums or elevators).

In an embodiment, a predetermined order may be present between the categories of devices to be controlled. For example, there may be a predetermined order in the order of the first category to the eighth category. When the electronic device identifies the first user input through the second object 319-1 while the first category is displayed, the electronic device may display the second category. When the electronic device identifies the first user input through the second object 319-1 while the second category is displayed, the electronic device may display the third category. When the electronic device identifies the first user input through the second object 319-2 while the first category is displayed, the electronic device may display the eighth category. Referring to FIG. 5, the electronic device may identify a user input through the first object 319-1 or the second object 319-2 displayed on the first user interface 510.

According to an embodiment, in operation 430, the electronic device may identify at least one device included in the selected category in response to identifying the first user input. For example, when the selected category is the first category, the electronic device may display first objects corresponding to all of the devices included in the house. For example, when the selected category is the second category, the electronic device may display only the first object corresponding to the display device. In FIG. 5, an example in which the first category is selected is described, and thus, all of the devices are displayed. However, when one of the second category to the eighth category is selected, the first object corresponding to some devices may not be displayed.

In an embodiment, when receiving a user input through the object 315, the electronic device may display the object 517. The object 517 may refer to an object representing other functions that may be performed by the electronic device displayed as a user input to the object 315 is identified. Although not illustrated in the drawings, the object 517 may include information about various functions related to the first user interface, such as a mode setting function and an automation operation function, in addition to the device editing function.

According to an embodiment, in operation 440, the electronic device may display a second user interface in which at least one first object corresponding to the at least one device is disposed according to the layout.

In an embodiment, the second user interface may refer to a user interface displayed when receiving a user input through the object 315 in the user interface 300 and identifying a user input for device editing through the displayed object 517.

In an embodiment, the second user interface 520 or 540 may include a plurality of first objects (e.g., the object 501 and the object 503) displayed on the first user interface 510.

In an embodiment, the electronic device may identify a second user input for editing through the first object displayed on the second user interface 520 or 540. For example, although not illustrated in the drawings, when the electronic device switches to an editing mode (when receiving a user input through the object 517) and displays the second user interface 520 or 540, a plurality of first objects may change into the form of an FAB button to transform to be able to receive the user's input (e.g., drag, drag-and-drop, tap, etc.).

In an embodiment, when identifying a user input for editing the plurality of objects through the object 517, the electronic device may display the second user interface 520 or 540.

According to an embodiment, in operation 450, the electronic device may identify a second user input for changing the location on the layout of one first object among at least one first object displayed according to the layout.

According to an embodiment, in operation 460, in response to identifying the second user input, the electronic device may determine whether the device corresponding to one first object to be relocated is relocatable. Whether relocating is possible may be determined according to whether the device is built in the apartment not to be moved.

In an embodiment, the second or third user interface 520 or 530 may include an object 505 for identifying a user input for finishing editing of the plurality of first objects and returning to the original first user interface. When the electronic device identifies a user input through the object 505, the electronic device may terminate the editing mode and return to the original mode (e.g., the first user interface).

In an embodiment, when the electronic device identifies whether the device is fixed and identifies that the device is fixed based on information about the device stored in the memory or the server, the electronic device may determine that the device corresponding to the selected first object is relocatable. Further, when the electronic device identifies that the device is not fixed, the electronic device may determine that the device corresponding to the selected first object is not relocatable.

According to an embodiment, when the electronic device determines that the device corresponding to the one first object is relocatable, in operation 470, the electronic device may display a third user interface in which the one first object is relocated and displayed on the layout to correspond to the second user input.

According to an embodiment, when the electronic device determines that the device corresponding to one first object is not relocatable, in operation 480, the electronic device may display a fourth user interface including information that relocating is impossible.

For example, referring to FIG. 5, the electronic device may identify a second user input 522 of dragging one first object 501 among at least one first object displayed according to the layout displayed through the second user interface 520. The second user input to the first object 501 may refer to a user input to change the location of the first object 501 from a first location 524 included in the fourth area (e.g., the fourth area 324) to a second location 526 included in the fifth area (e.g., the fifth area 325). The electronic device may determine that the air purifier which is the device corresponding to the first object 501 is not fixed, but is relocatable. The electronic device may relocate the first object 501 from the first location 524 which is the existing location to the second location 526 and display it on the third user interface 530.

Further, for example, referring to FIG. 5, the electronic device may identify a second user input 542 of dragging or panning one object 503 among at least one first object displayed according to the layout displayed through the second user interface 540. The second user input to the object 503 may refer to a user input to change the location of the object 503 from a first location 544 included in the fourth area (e.g., the fourth area 324) to a second location 546 included in the fifth area (e.g., the fifth area 325). The electronic device may determine that since the lighting device, which is a device corresponding to the object 503, is fixed, relocating is impossible. The electronic device may display the object 503, as it is, at the existing location 544 on the third user interface 550.

In an embodiment, the third user interface 530 or 550 may include an object 532 or 552 indicating information about whether relocating of the first object has succeeded. For example, the third user interface 530 may include object 532 including information indicating that relocating of the first object has succeeded (e.g., “The air purifier has moved to the master bedroom”). For example, the third user interface 550 may include object 552 including information indicating that relocating of the first object has failed (e.g., “Light 8 is a fixed device in the smart apartment. It is not relocatable”).

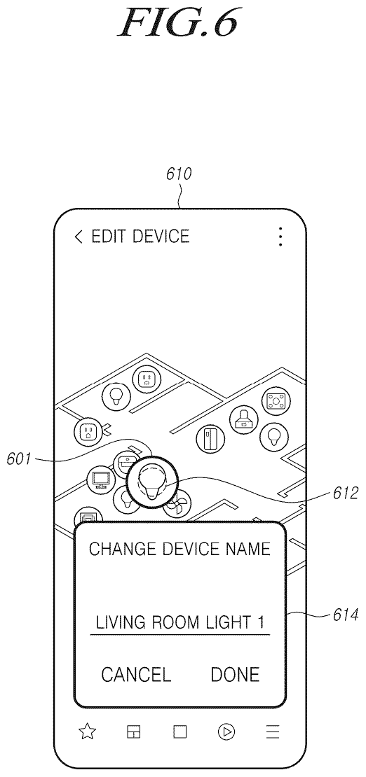

FIG. 6 illustrates an example of a user interface for device editing of an electronic device according to an embodiment of the disclosure. The electronic device of FIG. 6 may be a device corresponding to the electronic device 101 of FIG. 1.

In an embodiment, the second user interface may refer to a user interface displayed when receiving a user input through the object 315 in the user interface 300 and identifying a user input for device editing through the displayed object 517. The user interface 610 of FIG. 6 may represent an example of a user interface displayed when a user input is identified through the first object 601 on the second user interface.

In an embodiment, the electronic device may display an object 517 when identifying a user input through the object 315 of the user interface 300 or 510. Thereafter, when identifying a user input for device editing through the object 517, the electronic device may display a second user interface (e.g., the second user interface 520 or 540) related to device editing.

In an embodiment, when the electronic device identifies a user input 612 through the first object 601 included in the second user interface for device editing, the electronic device may display an object 614 for receiving a user input for changing the device name.

In an embodiment, a user input 612 may include various types of user inputs such as a tap, a double tap, and a long press.

Referring to FIG. 6, in an embodiment, when the electronic device identifies a user input for tapping the first object 601, the electronic device may display the object 614. The electronic device may identify a user input for inputting the name of the first object 601 through the object 614. In response to identifying the user input for inputting the name of the first object 601, the electronic device may set the input name as the name of the corresponding device.

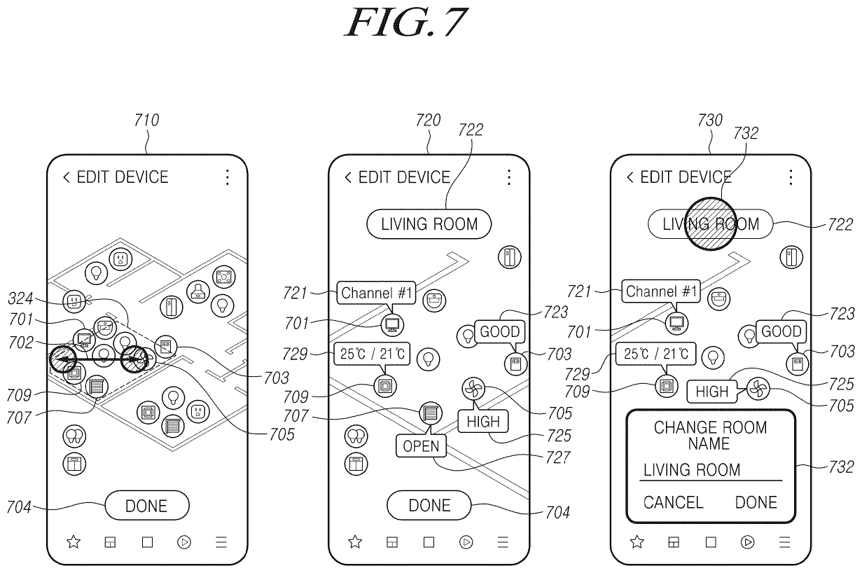

FIG. 7 illustrates an example of a user interface for device identification and editing of an electronic device according to an embodiment of the disclosure. The user interface 710, 720, or 730 described in the description of FIG. 7 may refer to the second user interface described in FIGS. 4, 5, and 6. In other words, the second user interface may refer to a user interface displayed when receiving a user input through the object 315 in the user interface 300 and identifying a user input for device editing through the displayed object 517.

In an embodiment, the second user interface 710 may include a plurality of first objects (e.g., the first object 701, the first object 703, the first object 705, the first object 707, and the first object 709).

In an embodiment, the second user interface 710 may include an object 704 (e.g., “done”) for identifying a user input for terminating the editing function.

In an embodiment, when identifying a user input for enlarging a specific area through the second user interface 710, the electronic device may display the second user interface 720 in which the specific area is enlarged. For example, when the electronic device identifies a user input 702 identified in the fourth area 324, the electronic device may display the second user interface 720 in which the fourth area 324 is enlarged and displayed. When the user wants to identify and change the device included in the living room, only the area corresponding to the living room may be enlarged on the user interface, and as the area is enlarged, the size of the space for display increases, so that the electronic device may display various information.

In an embodiment, a user input 702 may include a user input (e.g., spread or pinch-out) for enlarging the screen.

In an embodiment, the user input 702 may be identified in at least one area included in the layout (e.g., the layout 320). For example, the user input 702 may be identified in the first to sixth areas 321 to 326. It may include a user input (e.g., spread or pinch-out) to enlarge the screen.

In an embodiment, the electronic device may enlarge and display the area in which the user input 702 is identified. For example, referring to FIG. 5, since the user input 702 is identified in the fourth area 324, the electronic device may display the second user interface 720 in which the fourth area 324 is enlarged.

According to an embodiment, the second user interface 720 may include a plurality of first objects included in the enlarged area and an object including information about states of devices corresponding to the plurality of first objects. For example, the second user interface 720 may include an object 721 including information about content (e.g., Channel #1) currently being played by the TV, which is the device corresponding to the first object 701. For example, the second user interface 720 may include an object 723 including information about the current state (e.g., good air condition) of the air purifier, which is the device corresponding to the first object 703. For example, the second user interface 720 may include an object 725 including information about the current wind strength (e.g., strong wind) of the ventilator, which is the device corresponding to the first object 705. For example, the second user interface 720 may include an object 727 including information about the current state (e.g., an open state) of the curtain device, which is the device corresponding to the first object 707. For example, the second user interface 720 may include an object 729 including information about the current state (e.g., set temperature: 21 degrees, current temperature: 25 degrees), of the system air conditioner, which is the device corresponding to the first object 709.

In an embodiment, the second user interface 720 may include the object 722 including information about the area currently being enlarged and displayed. For example, the second user interface may include an object including information indicating that the currently enlarged area is the living room, which is the fourth area 324.

In an embodiment, when the electronic device identifies a user input 732 through the object 722 included in the second user interface 720, the electronic device may display the second user interface 730 including the object 722 for changing the name of the enlarged area. For example, when identifying a user input for selecting the object 722 (e.g., the living room), the electronic device may display the second user interface 730 including the object 722 (e.g., changing the room name).

In an embodiment, although not illustrated in the drawings, when identifying a user input for selecting a plurality of first objects (e.g., the first objects 701, 703, 705, 707, and 709) displayed on the second user interface 720, the electronic device may display an object for identifying a user input for changing the name of the device corresponding to the selected first object.

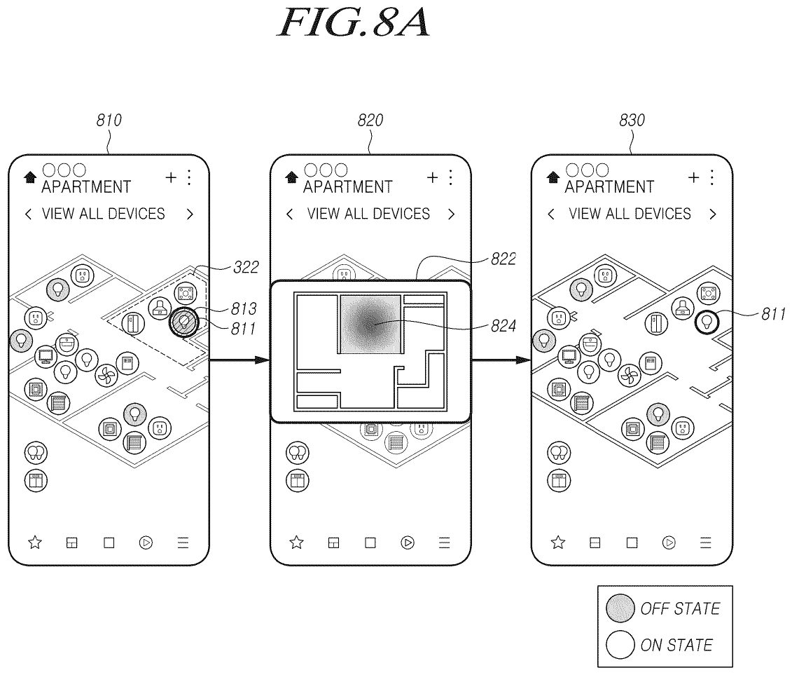

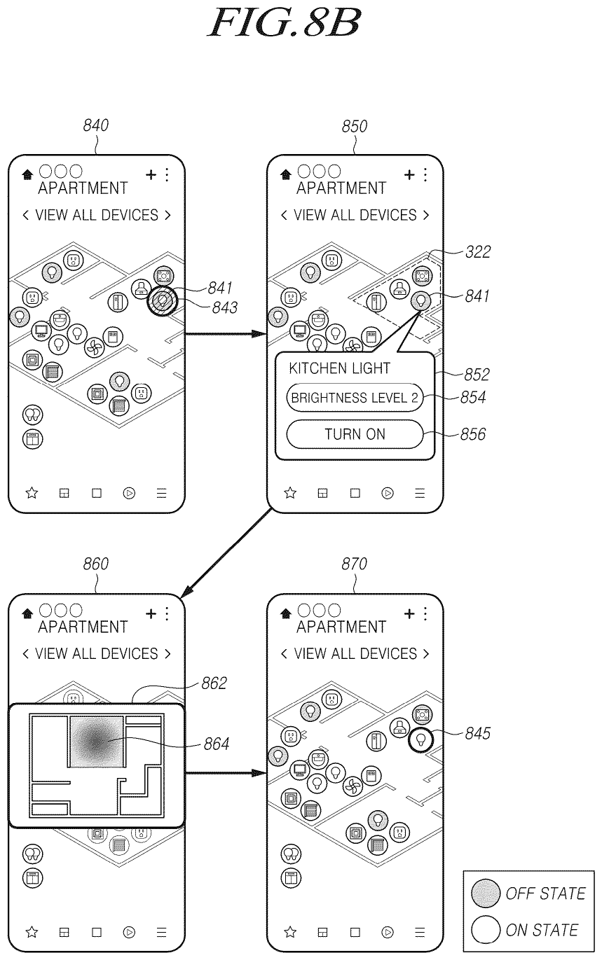

FIG. 8A illustrates an example of a user interface for device use of an electronic device according to an embodiment of the disclosure. FIG. 8B illustrates an example of a user interface for device use of an electronic device according to an embodiment of the disclosure. The electronic device described in FIGS. 8A and 8B may refer to the electronic device of FIG. 1. The user interface 810, 820, or 830 shown in FIGS. 8A and 8B may be a first user interface corresponding to the user interface 300 of FIG. 3.

In an embodiment, the electronic device may display a first user interface including information about use of the device. The information about the use of the device may include a preview screen representing a result displayed when the device is used, and a screen including a special effect regarding the form in which the device operates.

In an embodiment, the information about the use of the device may include information indicating that the device is in the first state or the second state when the device provides only a single function (e.g., when the lighting device simply includes an on/off function). In an embodiment, when the device provides a plurality of functions (e.g., when the lighting device is capable of adjusting brightness in addition to turning on/off), the information about the use of the device may include information (e.g., brightness information) about each of the plurality of functions.

In an embodiment, in the electronic device, the first user interface may include a plurality of first objects. When the electronic device identifies a user input (e.g., tap) through the first object displayed on the first user interface, the electronic device may display information about the device use of the device corresponding to the first object where a user input is identified. FIG. 8A may illustrate an example of a user interface displayed when a device provides only a single function, and FIG. 8B may illustrate an example of a user interface displayed when a device provides a plurality of functions.

Referring to FIG. 8A, in an embodiment, the electronic device may display a first object 811 representing a lighting device included in the second area 322 that is an area corresponding to the kitchen space through the first user interface 810. The electronic device may shade the surroundings of the first object 811, indicating that the lighting device is currently turned off. When the electronic device identifies a user input 813 through the first object 811, the electronic device may display the first user interface 820.

In an embodiment, the first user interface 820 may include an object 822 including a result displayed when the device corresponding to the first object 811 is controlled according to a user input 813 identified through the first object 811. For example, the object 822 may represent a portion 824 that brightens up in the house when the lighting device is turned on. In an embodiment, the object 822 may have the form of a pop-up window.

In an embodiment, the electronic device may release the display of the object a predetermined time (e.g., 3 seconds) after the object 822 is displayed.

In an embodiment, the electronic device may display the first user interface 830 after releasing the display of the object 822. The first user interface 830 may include a result of manipulating the first object 811. For example, the electronic device may display the first object 811 to indicate that the lighting device corresponding to the first portion 824 is turned on through the first user interface 830. Referring to FIG. 8A, the electronic device may display the first object 811, which used to be represented in the form that shading is included in the surroundings, in the form of a first object 811 in the form that no shading is included in the surroundings.

Referring to FIG. 8B, the electronic device may display a first object 841 indicating a lighting device included in the second area, which is an area corresponding to the kitchen space, through the first user interface 840. The electronic device may shade the surroundings of the first object 841, indicating that the lighting device is currently turned off. When the electronic device identifies a user input 843 through the first object 841, the electronic device may display the first user interface 850.

In an embodiment, the first user interface 850 may include an object 852 including information about the use of the lighting device corresponding to the first object 841. The object 852 including information about the use of the lighting device corresponding to the first object 841 may include an object 854 for adjusting the brightness of the lighting device and an object 856 for turning on or off the lighting device. When identifying a user input through the object 854, the electronic device may adjust the brightness of the lighting device corresponding to the first object 841 to correspond to a user input. When identifying a user input through the object 856, the electronic device may turn on or off the lighting device corresponding to the first object 841.

In an embodiment, when the electronic device identifies a user input for controlling the lighting device through the object 852, the electronic device may display the first user interface 860. The first user interface 860 may include an object 862 for displaying a result displayed when the device corresponding to the first object 841 operates according to a user input identified through the object 852. For example, the object 862 may indicate a portion 864 that is brightened in the house and the degree of brightness thereof. In an embodiment, the object 862 may have the form of a pop-up window.

In an embodiment, the electronic device may release the display of the object a predetermined time (e.g., 3 seconds) after the object 862 is displayed.

In an embodiment, the electronic device may display the first user interface 870 after releasing the display of the object 862. The first user interface 870 may include a first object 845. The first object 845 may refer to an object reflecting a control result according to the user's input to the first object 841. For example, the electronic device may display the first object 845 to indicate that the lighting device corresponding to the first object 841 has been controlled through the first user interface 850. Referring to FIG. 8B, the electronic device may display the first object 841, which used to be represented in the form that no shading is included in the surroundings, in the form of a first object 845 in the form that no shading is included in the surroundings.

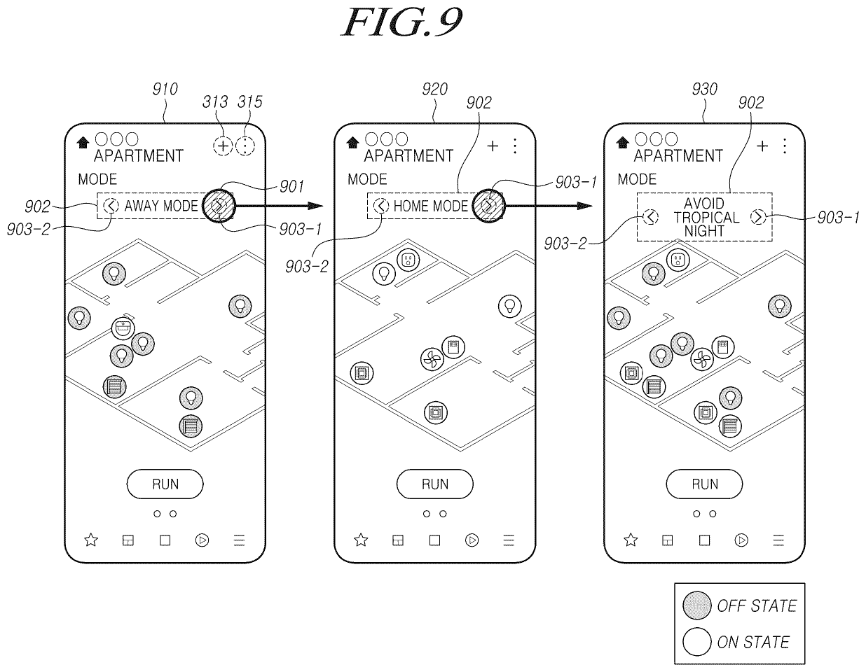

FIG. 9 illustrates an example of a user interface for mode change of an electronic device according to an embodiment of the disclosure. The electronic device described in FIG. 9 may represent a device corresponding to the electronic device 101 of FIG. 1.

Referring to FIG. 9, the electronic device according to an embodiment may display a third user interface 910, 920, or 930 for controlling devices included in the house according to a specific mode.

In an embodiment, the electronic device may display an object 517 in response to identifying a user input through the object 315. The electronic device may display the third user interface 910, 920, or 930 in response to identifying a user input (not illustrated) for selecting a function for operating according to the mode through the object 517.

In an embodiment, the third user interface 910, 920, or 930 may include an object 902 for representing information about the current mode and objects 903-1 and 903-2 for selecting the mode. For example, if a user input 901 is identified through the object 903-1 while displaying the third user interface 910, the electronic device may display the third user interface 920. For example, if a user input is identified through the object 903-1 while displaying the third user interface 920, the electronic device may display the third user interface 930. For example, if a user input is identified through the object 903-1 while displaying the third user interface 930, the electronic device may display the third user interface 910. For example, if a user input is identified through the object 903-2 while displaying the third user interface 910, the electronic device may display the third user interface 930.

In an embodiment, the electronic device may display the first object included in the user interface according to the selected mode. For example, when the selected mode is the first mode (e.g., “away mode”), and the mode switches to the away mode, the electronic device may display the lighting devices included in each area all in the off state, display the curtain devices all in the off state, and display the interphone in the on state based on control results of the devices (e.g., changing the lighting devices into the off state and changing the curtains into the closed state). For example, when the selected mode is the second mode (e.g., “home mode”), and the mode switches to the home mode, the electronic device may display the third user interface 920 based on the control results of the devices (e.g., changing the lighting devices disposed in the first area and the second area into the on state, changing the air conditioner, ventilator, and air purifier included in the fourth area into the on state, and changing the air conditioner disposed in the fifth area into the off state). For example, when the selected mode is the third mode (e.g., “tropical night avoidance mode”), and the mode switches to the tropical night avoidance mode, the electronic device may display the third user interface 930 based on the control results of the device (e.g., changing the lighting device into the off state, changing the curtain into the closed state, or changing the air conditioner and the ventilator all into the off state).

In an embodiment, although not illustrated in the drawings, the third user interface 910, 920, or 930 may display the results of operation of the devices in the form of a preview (e.g., a special effect, etc.) when executing each mode.

In an embodiment, the third user interface 910, 920, or 930 may include an object (not illustrated) (e.g., “preview”) for identifying a user input for previewing the operation results of the devices when operating according to the mode. For example, when the electronic device identifies a hovering input through an object for identifying a user input to preview the operation results of the devices included in the third user interface 910, 920, or 930, the electronic device may display a pop-up window showing the operation results of devices or an FAB represented on each first object. By providing an IoT mode interface using the map view, it is possible to prevent other devices than those expected by the user from operating when the corresponding mode is pressed while showing the related devices associated with the mode name.

In an embodiment, although not illustrated in the drawings, the electronic device may display information about whether the devices have been successfully executed according to the mode. For example, the electronic device may represent the first objects corresponding to the devices whose execution has been completed in a specific color or form and the first objects corresponding to the devices whose execution has failed in a different color from the specific color or a different form.

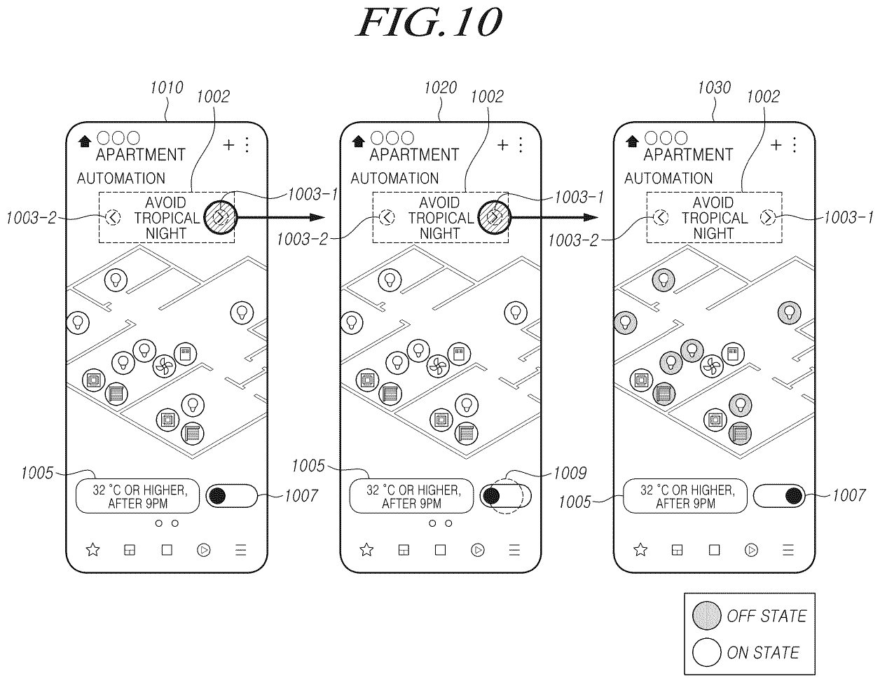

FIG. 10 illustrates an example of a user interface for automation function use of an electronic device according to an embodiment of the disclosure. The electronic device of FIG. 10 may be a device corresponding to the electronic device 101 of FIG. 1.

Referring to FIG. 10, the electronic device according to an embodiment may display a third user interface 1010, 1020, or 1030 for controlling devices included in a house according to an automation function.

In an embodiment, the electronic device may display an object 517 in response to identifying a user input through the object 315. The electronic device may display the third user interface 1010, 1020, or 1030 in response to identifying a user input (not illustrated) for selecting a function for operating according to the automation function through the object 517.

In an embodiment, the third user interface 1010, 1020, or 1030 may include an object 1002 (e.g., “avoid tropical night”) for representing information about the current automation function and objects 1003-1 and 1003-2 for selecting the automation function. For example, if a user input is identified through the object 1003-1 while displaying the third user interface 1010, the electronic device may display the third user interface 1020. For example, if a user input is identified through the object 1003-1 while displaying the third user interface 1020, the electronic device may display the third user interface 1030. For example, if a user input is identified through the object 1003-1 while displaying the third user interface 1030, the electronic device may display the third user interface 1010. For example, if a user input is identified through the object 1003-2 while displaying the third user interface 1010, the electronic device may display the third user interface 1030.

In an embodiment, the third user interface 1010, 1020, or 1030 may include an object 1005 (e.g., start the automation function after 21 PM, 32 degrees Celsius or higher) indicating information about a triggering condition of the automation function and an object 1007 for identifying a user input regarding whether it is triggered.

In an embodiment, when identifying a user input 1009 through the third user interface 1020, the electronic device may display the third user interface 1030. The third user interface 1030 may represent a result of controlling devices according to the automation function (e.g., changing the lighting devices all into the off state and changing the air conditioner into the off state). The third user interface 1030 may include a modification of the object 1007 indicating that it is currently operating in response to the identified user input 1009 to the object 1007.

In an embodiment, although not illustrated in the drawings, the electronic device may display the results of operation of the devices according to the selected automation function in the form of a preview. Further, the electronic device may display the results of controlling the devices (e.g., air conditioner on or light off) according to the automation function.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an electronic device for controlling a plurality of devices in a house, the method comprising:
displaying a first user interface where a plurality of first objects corresponding to the plurality of devices are disposed according to a predetermined layout to correspond to a structure of the house;
identifying a first user input for selecting a category of a device to be controlled through a second object included in the first user interface;
identifying at least one device included in the selected category in response to identifying the first user input;
displaying a second user interface where at least one first object corresponding to the at least one device is disposed according to the layout;
identifying a second user input for changing a location on the layout of one first object among the at least one first object displayed on the second user interface according to the layout;
determining whether a device corresponding to the one first object is relocatable in response to identifying the second user input;
when it is determined that the device corresponding to the one first object is relocatable, changing and displaying the location on the layout of the one first object to correspond to the second user input; and
when it is determined that the device corresponding to the one first object is not relocatable, displaying information indicating that relocating is impossible.

2. The method of claim 1, further comprising receiving information about the predetermined layout from memory of the electronic device or a server providing a smart apartment service.

3. The method of claim 1,
wherein the predetermined layout includes a plurality of areas, and
wherein the plurality of areas respectively correspond to spaces in the house.

4. The method of claim 3, wherein the plurality of areas include a shared area corresponding to a shared space other than the house.

5. The method of claim 3, wherein the second user input for changing the location on the layout of the one first object includes an input of dragging the one first object from one area among the plurality of areas to another area.

6. The method of claim 3, comprising:
identifying a user input for enlarging one area among the plurality of areas; and
enlarging and displaying the one area.

7. The method of claim 6, comprising:
identifying one or more first objects displayed in the one area;
identifying an operation state of one or more devices corresponding to the one or more first objects; and
displaying one or more objects including an operation state of the identified one or more devices.

8. The method of claim 1, further comprising, when determining that the device corresponding to the one first object is relocatable, displaying information indicating that relocating according to the second user input succeeds.

9. The method of claim 2, further comprising:
receiving information about whether the device corresponding to the one first object is a fixed device from the server; and
determining whether the device corresponding to the one first object is relocatable based on the received information about whether the device corresponding to the one first object is the fixed device.

10. The method of claim 1, further comprising:
identifying a user input for selecting an operation mode of the electronic device;
identifying at least one operation device controlled according to the operation mode; and
displaying an object indicating a result of executing the at least one operation device.

11. An electronic device for controlling a plurality of devices in a house, the electronic device comprising:
memory, comprising one or more storage media, storing instructions; and
at least one processor communicatively coupled to the memory,
wherein the instructions, when executed by the at least one processor individually or collectively, cause the electronic device to:
display a first user interface where a plurality of first objects corresponding to the plurality of devices are disposed according to a predetermined layout to correspond to a structure of the house,
identify a first user input for selecting a category of a device to be controlled through a second object included in the first user interface,
identify at least one device included in the selected category in response to identifying the first user input,
display a second user interface where at least one first object corresponding to the at least one device is disposed according to the layout,
identify a second user input for changing a location on the layout of one first object among the at least one first object displayed on the second user interface according to the layout,
determine whether a device corresponding to the one first object is relocatable in response to identifying the second user input,
when it is determined that the device corresponding to the one first object is relocatable, change and display the location on the layout of the one first object to correspond to the second user input, and
when it is determined that the device corresponding to the one first object is not relocatable, display information indicating that relocating is impossible.

12. The electronic device of claim 11, wherein the instructions that, when executed by the at least one processor individually or collectively, further cause the electronic device to receive information about the predetermined layout from the memory of the electronic device or a server providing a smart apartment service.

13. The electronic device of claim 11,
wherein the predetermined layout includes a plurality of areas, and
wherein the plurality of areas respectively correspond to spaces in the house.

14. The electronic device of claim 13, wherein the plurality of areas include a shared area corresponding to a shared space other than the house.

15. The electronic device of claim 13, wherein the second user input for changing the location on the layout of the one first object includes an input of dragging the one first object from one area among the plurality of areas to another area.

16. The electronic device of claim 13, wherein the instructions that, when executed by the at least one processor individually or collectively, further cause the electronic device to:
identify a user input for enlarging one area among the plurality of areas; and
enlarge and display the one area.

17. The electronic device of claim 16, wherein the instructions that, when executed by the at least one processor individually or collectively, further cause the electronic device to:
identify one or more first objects displayed in the one area;
identify an operation state of one or more devices corresponding to the one or more first objects; and
display one or more objects including an operation state of the identified one or more devices.

18. The electronic device of claim 11, wherein the instructions that, when executed by the at least one processor individually or collectively, further cause the electronic device to, when determining that the device corresponding to the one first object is relocatable, display information indicating that relocating according to the second user input succeeds.

19. One or more non-transitory computer-readable storage media storing one or more computer programs including computer-executable instructions that, when executed by one or more processors of an electronic device individually or collectively, cause the electronic device to perform operations, the operations comprising:
displaying a first user interface where a plurality of first objects corresponding to a plurality of devices are disposed according to a predetermined layout to correspond to a structure of a house;
identifying a first user input for selecting a category of a device to be controlled through a second object included in the first user interface;
identifying at least one device included in the selected category in response to identifying the first user input;
displaying a second user interface where at least one first object corresponding to the at least one device is disposed according to the layout;
identifying a second user input for changing a location on the layout of one first object among the at least one first object displayed on the second user interface according to the layout;
determining whether a device corresponding to the one first object is relocatable in response to identifying the second user input;
when it is determined that the device corresponding to the one first object is relocatable, changing and displaying the location on the layout of the one first object to correspond to the second user input; and
when it is determined that the device corresponding to the one first object is not relocatable, displaying information indicating that relocating is impossible.

20. The one or more non-transitory computer-readable storage media of claim 19, the operations further comprising receiving information about the predetermined layout from memory of the electronic device or a server providing a smart apartment service.
